(19) United States
(12) Patent Application Publication
(10) Pub. No.: US 2012/0056470 A1
(43) Pub. Date: Mar. 8, 2012

(54) BRAKING CONTROL METHOD FOR ELECTRIC VEHICLE

(75) Inventor: Sang Joon Kim, Seoul (KR)

(73) Assignee: HYUNDAI MOTOR COMPANY, Seoul (KR)

(21) Appl. No.: 12/951,487

(22) Filed: Nov. 22, 2010

(30) Foreign Application Priority Data
Sep. 3, 2010 (KR) 10-2010-0086506

(51) Int. Cl. B60T 13/74; B60L 7/24; B60L 7/26; B60T 13/58

(52) U.S. Cl. 303/3

(57) ABSTRACT

The present invention features braking control methods for an electric vehicle. Such methods include identifying a vehicle operational condition occurring during regenerative braking that reduces regenerative braking capacity; linearly reducing the amount of regenerative braking of a motor of the electric vehicle after identifying such a vehicle operational condition; and at the same time, increasing the amount of hydraulic braking of a hydraulic braking system to compensate for the reducing of the amount of regenerative braking. Such operational conditions include when the temperature of a motor or battery is increased above a predetermined level during regenerative braking or when the shift lever is shifted to Neutral (N) position by a driver during regenerative braking.

### CROSS-REFERENCE TO RELATED APPLICATION

This application claims under 35 U.S.C. §119(a), priority to and the benefit of Korean Patent Application No. 10-2010-0086506 filed Sep. 3, 2010, the entire contents of which are incorporated herein by reference.

### BACKGROUND

1. Technical Field

The present invention generally relates to a braking control method for an electric vehicle. More particularly, the present invention relates to a braking control method for an electric vehicle, which effectively handles reduction in braking force caused by a sharp reduction in the amount of regenerative braking and a delay in hydraulic response. More specifically, such a backing control method when the temperature of a motor or battery is increased above a predetermined level or when the shift lever is shifted to Neutral (N) position by a driver, in which regenerative braking by the motor is impossible.

2. Background Art

A hybrid vehicle, in a broad sense is a vehicle driven by efficiently using at least two different types of power sources. In most cases, the term hybrid vehicle is associated with a vehicle that is driven by an engine, such as an internal combustion engine that generates a rotational force by burning fuel (fossil fuel such as gasoline), and an electric motor which generates a rotational force using the electric power of a battery.

In a particular application, a hybrid vehicle is a vehicle that employs an electric motor as an auxiliary power source as well as an internal combustion engine, where characteristics of the motor provide a reduction in exhaust gas and an improvement in fuel efficiency. To meet the demands of today's society for improved fuel efficiency and the development of a more environmentally friendly product, research on hybrid vehicles is being actively conducted.

Such a hybrid vehicle can be driven in a number of modes. The hybrid vehicle when driven in an electric vehicle (EV) mode, is directed to a pure electric vehicle mode using only the power of the electric motor (i.e., drive motor). In the hybrid electric vehicle (HEV) mode, which is an auxiliary mode, the rotational force of the engine is used as a main power source and the rotational force of the drive motor as an auxiliary power source. In a regenerative braking (RB) mode, the braking energy or inertia energy of the vehicle produced by braking or during driving by inertia is recovered by power generation of the drive motor and charged in a battery.

Such a hybrid vehicle uses the engine's mechanical energy and the battery's electrical energy simultaneously in the optimal operating range of the engine and the drive motor, and the braking energy is recovered by the drive motor, it is possible to improve the fuel efficiency of the vehicle and achieve efficient energy utilization.

For electric vehicles such as a pure electric vehicle (EV) driven by operating a drive motor and a fuel cell electric vehicle (FCEV) driven by operating a drive motor using electric power generated by a fuel cell as well as the hybrid vehicle, fuel efficiency is improved by regenerative braking in which kinetic energy is converted into electrical energy during braking. Such vehicles use a hydraulic braking system in combination with such regenerative braking to slow or stop the vehicle. Thus, for such a combined braking system an appropriate distribution between the braking force by a hydraulic braking system, i.e., the hydraulic braking force, and the electrical braking force by the generation and rotational resistance of the motor, i.e., the regenerative braking force.

When a driver depresses a brake pedal, the braking force is distributed as follows: the total amount of braking required=the amount of hydraulic braking+the amount of regenerative braking (power generation and battery charge by the motor).

Referring to FIG. 1, which is a diagrammatic view of a braking control process of a conventional electric vehicle, the following discusses shortcomings with the braking force distribution and braking control process of conventional electric vehicles. As shown in FIG. 1, the battery charge by the motor is limited as the temperature of the motor or battery is increased above a predetermined level during regenerative braking. Also, the charging of the battery by the motor is limited in the case, where the shift lever is shifted to Neutral (N) position by a driver during regenerative braking.

First, the situations where a failure in the braking force during braking may be caused are as follows:

(1) When a sudden power limitation is caused (i.e., the regenerative braking torque of the motor is limited) as the temperature of the motor or battery is increased above a predetermined level during regenerative braking; and

(2) When the shift lever is shifted from the Drive (D) position to the neutral (N) position by a driver during braking (i.e., when the motor shaft and the axle are physically separated).

In a typical electric vehicle, when the temperature of the motor or battery is increased above a predetermined level, the charging power (i.e., regenerative braking) is suddenly limited. Further, in the case where the motor shaft and the axle are physically separated, i.e., when the shift lever is shifted to the N position during braking, the regenerative braking force by the motor cannot be transmitted to the vehicle as deceleration torque. Thus, the vehicle can be decelerated only using the hydraulic braking system.

Therefore, in the above two cases, as shown in FIG. 1, the amount of regenerative braking is sharply reduced, and thus in order to obtain a sufficient braking force, it is necessary to increase the amount of hydraulic braking as much as there is a reduction in regenerative braking.

However, the hydraulic response of the hydraulic braking system is not fast enough to compensate for the sharp reduction in regenerative braking, and thus the braking force is reduced by the delay in hydraulic response. Therefore, there continues to be a need for dealing with these shortcomings.

It thus would be desirable to provide methods for controlling the braking of an electric vehicle which can handle a reduction in braking force resulting from a reduction in regenerative braking and the delay in a response by a hydraulic braking system. It would be particularly desirable to provide such methods that would can handle a reduction in braking force in the case where the temperature of the motor or battery is increased above a predetermined temperature or in the case where the transmission is shifted into the Neutral position by a driver. Such methods preferably would not require greater skill than that normally required to operate a motor vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention features a braking control method for an electric vehicle. Such a braking control method advantageously handles the above described shortcomings of the reduction in braking force caused by a sharp reduction in the amount of regenerative braking and a delay in hydraulic response in the case where the temperature of a motor or battery is increased above a predetermined level or in the case where the shift lever is shifted to Neutral (N) position by a driver (i.e., when the motor shaft and the axle are physically separated), where regenerative braking by the motor is not possible.

According to one aspect of the present invention, there is featured a braking control method for an electric vehicle. Such a method includes detecting a position of shift lever to neutral (N) during regenerative braking; linearly reducing the amount of regenerative braking of a motor at a time when the manipulation of the shift lever to the N position is detected and, at the same time, increasing the amount of hydraulic braking of a hydraulic braking system to compensate for the amount of braking; and allowing the shift lever to be shifted to the N position after a predetermined time has elapsed from the time when the manipulation of the shift lever to the N position is detected.

In particular embodiments, the step of increasing the amount of hydraulic braking, further includes increasing the amount of hydraulic braking to the total amount of braking required as a target value.

In another embodiment, the methods of the present invention further includes: determining whether the temperature of the motor or battery has increased to a predetermined reference temperature-2 during regenerative braking; and linearly reducing the amount of regenerative braking of the motor and, at the same time, increasing the amount of hydraulic braking of the hydraulic braking system to compensate for the amount of braking, if the temperature of the motor or battery is determined to have reached the reference temperature-2.

In still another embodiment, the reference temperature-2 may be a temperature set to be lower than a predetermined reference temperature-1, a temperature for determining whether the temperature of the motor or battery is above a predetermined level at which the regenerative braking is to be completely stopped. In such an embodiment, the amount of regenerative braking is reduced at a time when the temperature of the motor or battery reaches the reference temperature-2 such that the regenerative braking is completely stopped when the temperature of the motor or battery reaches the reference temperature-1.

In yet another embodiment, when the temperature of the motor or battery reaches the reference temperature-2, the amount of hydraulic braking is increased to the total amount of braking required as a target value.

In further aspects/embodiments of the present invention there is feature another braking control method for an electric vehicle. Such a method includes identifying a vehicle operational condition occurring during regenerative braking or a braking operation of the electric vehicle and that reduces regenerative braking capacity. In such a case, the methods further includes linearly reducing the amount of regenerative braking of a motor of the electric vehicle after identifying such a vehicle operational condition, and at the same time, increasing the amount of hydraulic braking of a hydraulic braking system to compensate for the reducing of the amount of regenerative braking.

In further embodiments, the operational condition being identified corresponds to the detection of a position of shift lever in neutral (N) during regenerative braking. Such methods further include linearly reducing the amount of regenerative braking of a motor at a time when the manipulation of the shift lever to the N position is detected, and allowing the shift lever to be shifted to the N position after a predetermined time from the time when the manipulation of the shift lever to the N position is detected.

In further embodiments, the operational condition being identified corresponds to determining whether the temperature of the motor or battery increases and reaches a predetermined reference temperature-2 during regenerative braking. Such methods further includes linearly reducing the amount of regenerative braking of the motor if the temperature of the motor or battery reaches the reference temperature-2.

In further embodiments, the reference temperature-2 is a temperature set to be lower than a predetermined reference temperature-1, a temperature corresponding to a predetermined level at which the regenerative braking is to be completely stopped. In more particular embodiments, the reference temperature-2 is established so that the regenerative braking is completely stopped when the temperature of the motor or battery reaches the reference temperature-1.

In yet further embodiments, wherein said increasing of the amount of hydraulic braking, includes increasing the amount of hydraulic braking to the total amount of braking required as a target value, such as when the temperature of the motor or battery reaches the reference temperature-2.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Other aspects and preferred embodiments of the invention are discussed infra.

### BRIEF DESCRIPTION OF THE DRAWINGS

For a fuller understanding of the nature of the present invention as well as the above and other features of the present invention, reference is made to the following detailed description taken in conjunction with the accompanying drawing figures. In the figures, reference numbers refer to the same or equivalent parts of the present invention throughout the several figures of the drawing.

FIG. 1 is a diagram view of a braking control process of a conventional electric vehicle.

FIG. 2 is a block diagram view illustrating a braking control method for an electric vehicle in accordance with the present invention.

FIGS. 3 and 4 are diagrammatic views that illustrate a state where a regenerative braking torque of a motor is controlled by the braking control method of the present invention.

FIGS. 5 and 6 are high level flowcharts illustrating embodiments of the braking control method of the present invention.

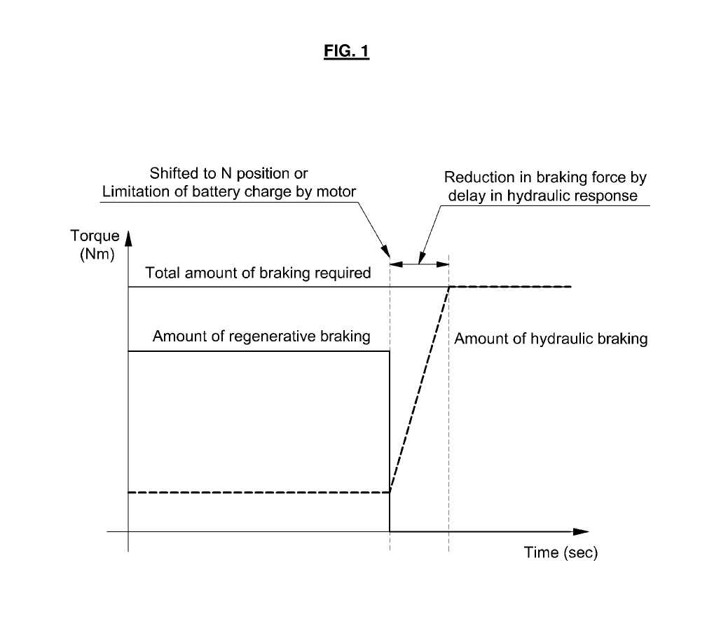

Reference numerals and/or characters set forth in the drawings includes reference to the following elements as further discussed below:

| | |
|---|---|
| Tb: battery temperature | Tm: motor temperature |
| T1_b, T1_m: reference temperature 1 | |
| T2_b, T2_m: reference temperature 2 | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter reference will now be made in detail to various embodiments of the present invention, examples of which are illustrated in the accompanying drawings and described below. It is will be understood that the following present description is not intended to limit the scope of the present invention to those exemplary embodiments. It shall be understood that the scope of the invention shall embrace various alternatives, modifications, equivalents and other embodiments, which may be included within the spirit and scope of the invention as defined by the appended claims.

The present invention provides or features a braking control method for an electric vehicle. Such braking control methods advantageously address the shortcomings of conventional methods concerning the reduction in braking force caused by a sharp reduction in the amount of regenerative braking and a delay in hydraulic response under conditions where the regenerative braking by a motor (i.e., drive motor for driving the vehicle) is not possible. For example, in the case where the temperature of a motor or battery is increased above a predetermined level or in the case where the shift lever is shifted to Neutral (N) position by a driver (i.e., when the motor shaft and the axle are physically separated).

In further aspects/embodiments of the present invention there is feature another braking control method for an electric vehicle. Such a method includes identifying a vehicle operational condition occurring during regenerative braking or a braking operation of the electric vehicle and that reduces regenerative braking capacity. In such a case, the methods further includes linearly reducing the amount of regenerative braking of a motor of the electric vehicle after identifying such a vehicle operational condition, and at the same time, increasing the amount of hydraulic braking of a hydraulic braking system to compensate for the reducing of the amount of regenerative braking.

In further embodiments, the operational condition being identified corresponds to the detection of a position of shift lever in neutral (N) during regenerative braking. Such methods further include linearly reducing the amount of regenerative braking of a motor at a time when the manipulation of the shift lever to the N position is detected, and allowing the shift lever to be shifted to the N position after a predetermined time from the time when the manipulation of the shift lever to the N position is detected.

In further embodiments, the operational condition being identified corresponds to determining whether the temperature of the motor or battery increases and reaches a predetermined reference temperature-2 during regenerative braking. Such methods further includes linearly reducing the amount of regenerative braking of the motor if the temperature of the motor or battery reaches the reference temperature-2.

In further embodiments, the reference temperature-2 is a temperature set to be lower than a predetermined reference temperature-1, a temperature corresponding to a predetermined level at which the regenerative braking is to be completely stopped. In more particular embodiments, the reference temperature-2 is established so that the regenerative braking is completely stopped when the temperature of the motor or battery reaches the reference temperature-1.

In yet further embodiments, wherein said increasing of the amount of hydraulic braking, includes increasing the amount of hydraulic braking to the total amount of braking required as a target value, such as when the temperature of the motor or battery reaches the reference temperature-2.

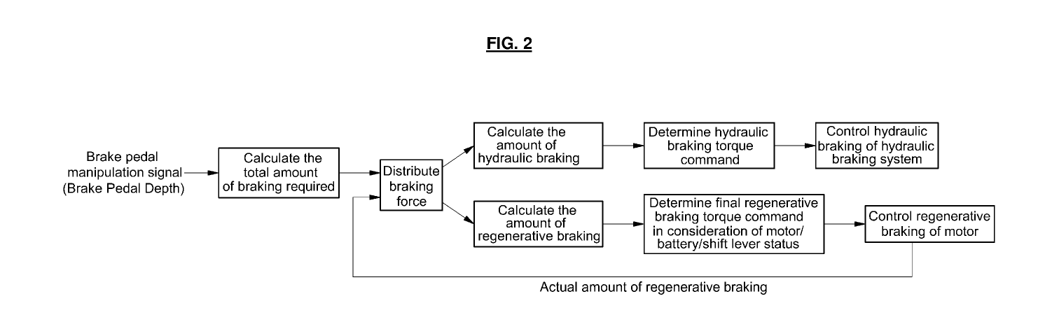

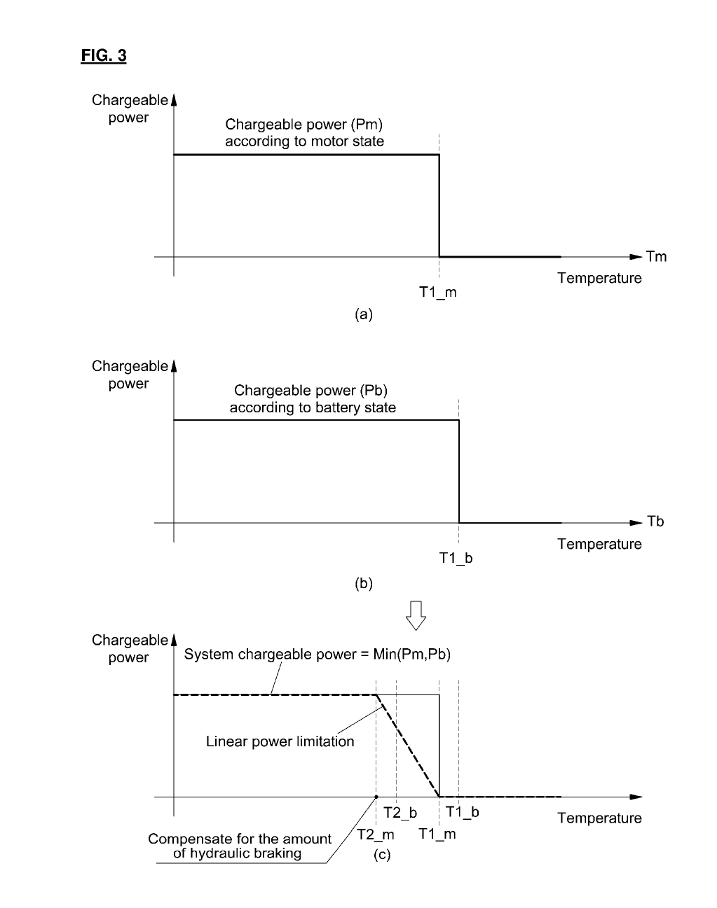

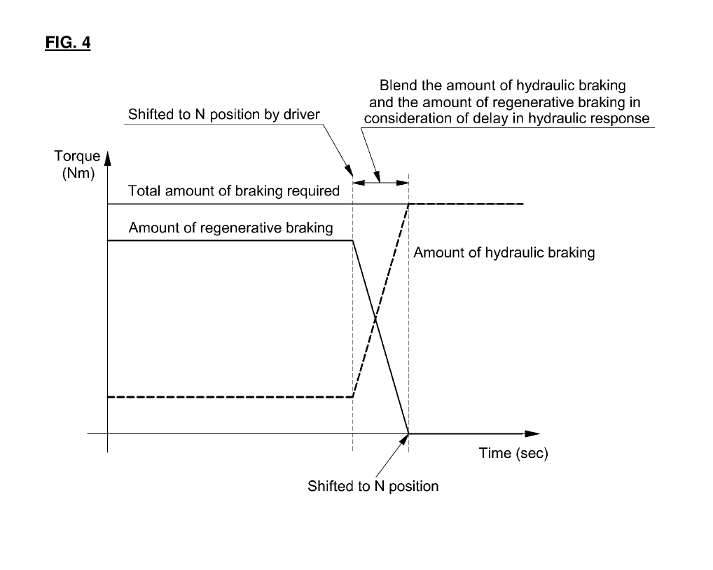

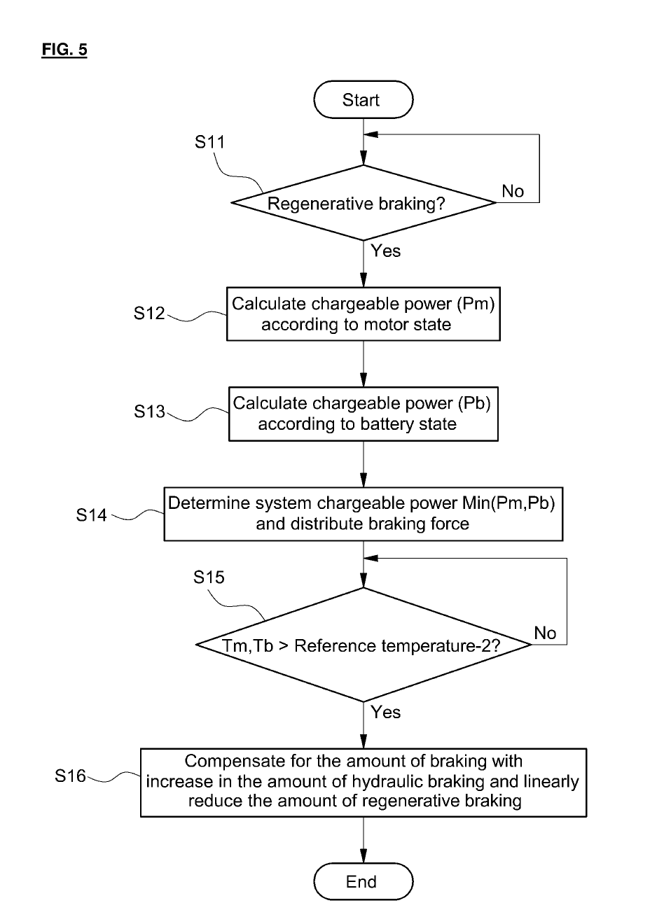

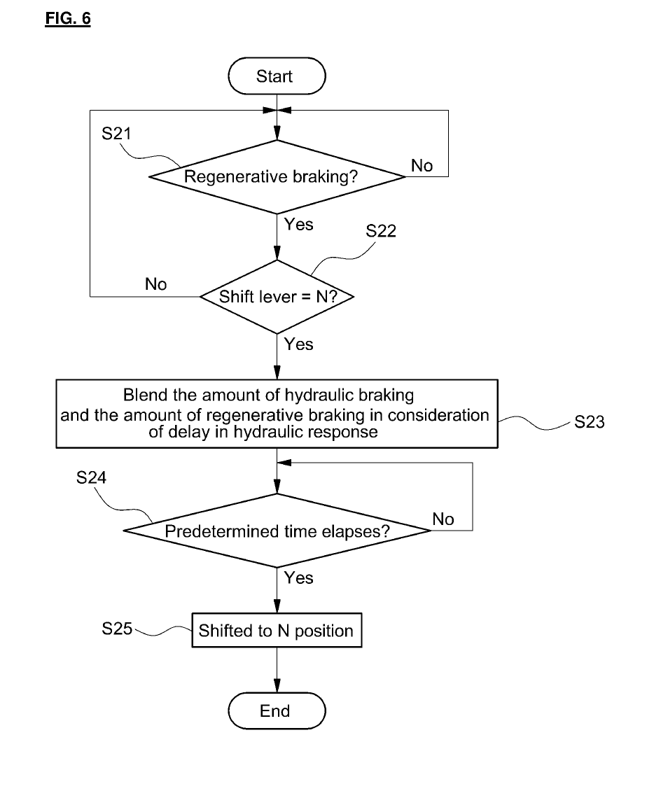

Referring now to FIGS. 2-4, there is shown a block diagram (FIG. 2) illustrating a braking control method for an electric vehicle in accordance with a preferred embodiment of the present invention, and diagrams (FIGS. 3-4) illustrating a state where a regenerative braking torque of a motor is controlled by the braking control method in accordance with a preferred embodiment of the present invention. More particularly, FIG. 3 illustrates a braking torque control process when the temperature of the motor is increased above a predetermined level and FIG. 4 illustrates a braking torque control process when the shift lever is shifted to the N position by a driver. As to FIGS. 5-6, these figures are flowcharts illustrating the braking control method in accordance with a preferred embodiment of the present invention.

In further aspects/embodiments of the present invention, such braking control methods include providing an integrated controller, where the control process according to the present invention are performed by an integrated controller. As a typical electric vehicle is equipped with a superior controller and various controllers for each system, the following describes the control process using such a superior controller and the various other controllers.

A vehicle control unit (VCU) functions as the superior controller. The various controllers are connected through a communication system or means (e.g., a CAN communication line) to transmit and receive information to and from each other based on a vehicle control unit (VCU) as a superior controller.

The control process of the present invention are under the cooperative control of the controllers. For example, a motor control unit (MCU) (including an inverter) for controlling the overall operation of the motor, a transmission control unit (TCU) for controlling a transmission, a battery management system (BMS) for monitoring and managing the state of charge of a battery, and a brake control unit (BCU) for controlling the overall operation of a hydraulic braking system as well as the VCU are each configured to perform the control process.

As shown in FIG. 2, the vehicle control unit receives a signal according to the amount of depression of a brake pedal by a driver (i.e., brake pedal depth). The VCU calculates the total amount of braking required based on the signal, and calculates the amount of regenerative braking and the amount of hydraulic braking, respectively, to satisfy the total amount of braking required. Accordingly, the vehicle control unit determines a final regenerative braking torque corresponding to the amount of regenerative braking, transmits it to the motor control unit, determines a hydraulic braking torque corresponding to the amount of hydraulic braking, and transmits it to the brake control unit.

Then, the motor control unit controls the regenerative braking of the motor based on the regenerative braking torque command received from the vehicle control unit, and the brake control unit controls the hydraulic braking through hydraulic control of the hydraulic braking system based on a hydraulic braking torque command.

In the calculation of the amount of regenerative braking, the chargeable power according to the state of the motor and battery is considered. Further the amount of regenerative braking (i.e., charging power) is linearly reduced and, at the same time, the amount of hydraulic braking is increased to compensate for the amount of braking, according to the temperature of the motor and battery (whether it is increased to a predetermined level) or the position of the shift lever (whether it is shifted to the N position). In this way, the total amount of braking required is satisfied.

This braking control process of the present invention will be described in more detail below. First, the braking control process when the temperature of the motor or battery is increased above a predetermined level during regenerative braking will be described with reference to FIGS. 3 and 5. As indicated herein, when the temperature of the motor or battery is increased above a predetermined level during regenerative braking, the regenerative braking by the motor (i.e., power generation and battery charge by the motor) is not possible.

A typical vehicle control unit calculates a chargeable power according to the state of the motor and a chargeable power according to the state of the battery based on status information of the motor and the battery received from the motor control unit and the battery control unit during regenerative braking, selects a smaller value between them as a system chargeable power, and determines the amount of regenerative braking and the regenerative braking torque based on the same.

In this process, when the motor and/or battery temperature is/are lower than a reference temperature, the amount of regenerative braking and the regenerative braking torque are determined based on the system chargeable power [Min(Pm,Pb)], a smaller value between the chargeable power (Pm) according to the state of the motor and the chargeable power (Pb) according to the state of the battery. However, when the motor temperature (Tm) and/or the battery temperature (Tb) is increased above a predetermined reference temperature (T1_{—}m or T1_{—}b), the charging power (i.e., regenerative braking) is suddenly limited. In other words, the regenerative braking is stopped when the motor temperature or the battery temperature reaches the reference temperature) in the conventional method [refer to (a) and (b) of FIG. 3].

According to the methods of the present invention, the amount of regenerative braking (i.e., charging power) and the regenerative braking torque are linearly reduced at a temperature before the reference temperature (motor reference temperature T1_{—}m and battery reference temperature T1_{—}b) (hereinafter referred to as reference temperature-1) in consideration of the delay in hydraulic response of the hydraulic braking system as shown in (c) of FIG. 3.

That is, a reference temperature-2 (motor reference temperature T2_M and battery reference temperature T2_{—}b), which is lower than the reference temperature-1 (T1_{—}m and T1_{—}b), is predetermined. If it is determined that the motor temperature (Tm) or the battery temperature (Tb) increases and reaches the reference temperature-2 (T2_M or T2_{—}b), the amount of regenerative braking and the regenerative braking torque are linearly reduced as the motor temperature (Tm) or the battery temperature (Tb) increases from the time when the motor temperature or the battery temperature reaches the reference temperature-2.

In this process, the vehicle control unit compares the motor temperature (Tm) and the battery temperature (Tb) received from the motor control unit and the battery control unit with the reference temperature-1 (T1_{—}m and T1_{—}b) and the reference temperature-2 (T2_{—}m and T2_{—}b) during vehicle braking. If the motor temperature and/or the battery temperature increases and reaches the reference temperature-2, the process acts to reduce the amount of regenerative braking at a predetermined slope until the motor temperature or the battery temperature reaches the reference temperature-1. The regenerative braking is completely stopped at the reference temperature-1 (i.e., the regenerative braking is reduced to 0).

The vehicle control unit also determines a torque command corresponding to the amount of regenerative braking during the linear reduction of regenerative braking and outputs it to the motor control unit. Then, the motor control unit controls the regenerative braking of the motor based on the regenerative braking torque command received from the vehicle control unit.

Moreover, at a time when the motor temperature and/or the battery temperature reaches the reference temperature-2, the vehicle control unit increases the amount of hydraulic barking to satisfy the total amount of braking required as a target value.

As such, in the present invention, when the amount of regenerative braking is reduced and the amount of hydraulic braking is increased (e.g., in the case where the temperature of the motor or battery is increased above a predetermined level), the amount of regenerative braking (i.e., charging power) is linearly reduced at a temperature before the over temperature condition in consideration of the delay in hydraulic response. Such actions, thereby effectively and advantageously deals with the conventional problem of reduction in braking force.

In particular, from the time when the temperature reaches the reference temperature-2 to the time when the temperature reaches the reference temperature-1, the amount of regenerative braking and the amount of hydraulic braking are blended.

In the above described control process, the reference temperature-1 corresponds to a temperature at which the regenerative braking (battery charge by the motor) is completely stopped, i.e., a reference temperature for determining whether the temperature of the motor or battery is above a predetermined level at which the sudden power limitation is performed in the conventional method. The reference temperature-2 according to the present invention is a temperature, which is set to be lower than the reference temperature-1 such that the linear power reduction is performed at a temperature before the sudden power limitation. The reference temperature-2 is preferably determined and established in consideration of the hydraulic response characteristics of the hydraulic braking system mounted in the vehicle.

The following discussion is directed to the braking control process of the present invention when the shift lever is shifted to the N position by a driver during braking and particular reference shall be made to FIGS. 4 and 6. In further aspects/embodiments, the braking control process according to the present invention is such that the regenerative braking and the hydraulic braking are blended when the manipulation of the shift lever to the N position is detected in consideration of the delay in hydraulic response. More particularly, such process are implemented by linearly reducing the regenerative braking torque of the motor.

More particularly and in the case where the shift lever is shifted to the N position by the driver during regenerative braking, the amount of regenerative braking is linearly reduced and, at the same time, the amount of hydraulic braking is increased to satisfy the total amount of braking required in consideration of the delay in hydraulic response and, at the same time. When shifted to neutral, the regenerative braking force cannot be transmitted to the vehicle as the deceleration torque as the motor shaft and the axle are physically separated. After the lapse of a predetermined time (i.e., predetermined time has elapsed), the shift lever of the transmission is shifted to the N position. For example, after a predetermined time after linearly reducing was started or the driver shifter into neutral, the shift lever of the transmission is actually shifted to the N position.

In this process, when the vehicle control unit receiving a signal indicating the manipulation of the shift lever from the transmission control unit, which detects that the shift lever is shifted to the N position by the driver, the vehicle control unit linearly reduces the amount of regenerative braking (i.e., charging power) at a predetermined slop for a predetermined time and, at the same time, increases the amount of hydraulic braking to the total amount of braking required as a target value at the time when the manipulation of the shift lever to the N position is detected in the same manner as the case where the temperature of the motor or battery is increased above a predetermined level.

After the lapse of a predetermined time from the time when the manipulation of the shift lever to the N position is detected, the vehicle control unit transmits a shift command to the transmission control unit. The transmission control unit then shifts the shift lever to the N position after the lapse of the predetermined time so the transmission is in neutral. In other words, after the shift lever is shifted to the N position by the driver, the shifting of the shift lever to the N position (i.e., physical separation of the motor shaft and the axle) is delayed for the predetermined time during which the regenerative braking and the hydraulic braking are blended.

In particular illustrative embodiments, the predetermined time is determined by considering the delay in hydraulic response of the hydraulic braking system mounted in the vehicle. Otherwise, the transmission control unit may perform the shifting of the shift lever to the N position when determining that the predetermined time elapses from the time when the manipulation of the shift lever to the N position is detected without any command from the vehicle control unit.

The methods of the present invention make it possible to overcome or substantially mitigate the conventional problem or shortcomings of reduction in braking force caused in the case where the shift lever is shifted to the N position, i.e., where the motor shaft and the axle are physically separated, during regenerative braking. This is accomplished in the present invention in such a manner that the amount of regenerative braking is linearly reduced, the amount of hydraulic braking is increased to compensate for the amount of braking, and the shift lever is shifted to the N position after the lapse of the predetermined time in which the hydraulic response characteristics are considered.

In particular, from the time when the manipulation of the shift lever to the N position is detected to the predetermined time, the amount of regenerative braking and the amount of hydraulic braking are blended, and thus it is possible to overcome/substantially mitigate the problem of reduction in braking force.

As described above, according to the braking control method for the electric vehicle of the present invention, in the case where the shift lever is shifted to the N position during regenerative braking, the amount of regenerative braking is linearly reduced, the amount of hydraulic braking is increased to compensate for the amount of braking, and then the shift lever is shifted to the N position. In this way, the amount of regenerative braking and the amount of hydraulic braking are blended before the motor shaft and the axle are physically separated, thereby obtaining a sufficient braking force. Moreover, since the motor shaft and the axle are separated after the amount of hydraulic braking is increased, it is possible to overcome/substantially mitigate the problem/shortcomings of reduction in braking force.

Moreover, the amount of regenerative braking is linearly reduced and, at the same time, the amount of hydraulic braking is increased before the regenerative braking should be completely stopped when the temperature of the motor or battery is increased above a predetermined level such that the compensation for the amount of braking with the increase in the amount of hydraulic braking is completed at a time when the temperature of the motor or battery is increased above a predetermined level. In this way, the methods of the present invention overcome/substantially mitigate the problem/shortcomings of reduction in braking force caused by the delay in hydraulic response of the hydraulic braking system.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A braking control method for an electric vehicle, the method comprising:
detecting a position of shift lever to neutral (N) during regenerative braking;
linearly reducing the amount of regenerative braking of a motor at a time when the manipulation of the shift lever to the N position is detected and, at the same time, increasing the amount of hydraulic braking of a hydraulic braking system to compensate for the amount of braking; and
allowing the shift lever to be shifted to the N position after a predetermined time from the time when the manipulation of the shift lever to the N position is detected.

2. The method of claim 1, wherein said increasing of the amount of hydraulic braking, includes increasing the amount of hydraulic braking to the total amount of braking required as a target value.

3. The method of claim 1, further comprising:
determining whether the temperature of the motor or battery increases and reaches a predetermined reference temperature-2 during regenerative braking; and
linearly reducing the amount of regenerative braking of the motor if the temperature of the motor or battery reaches the reference temperature-2 and, at the same time, increasing the amount of hydraulic braking of the hydraulic braking system to compensate for the amount of braking.

4. The method of claim 3, wherein when the temperature of the motor or battery reaches the reference temperature-2, said increasing the amount of hydraulic braking further includes increasing the amount of hydraulic breaking to the total amount of braking required as a target value.

5. The method of claim 3, wherein the reference temperature-2 is a temperature set to be lower than a predetermined reference temperature-1, a temperature corresponding to a predetermined level at which the regenerative braking is to be completely stopped, and wherein said linearly reducing includes linearly reducing the amount of regenerative braking when the temperature of the motor or battery is determined to reach the reference temperature-2, whereby the regenerative braking is completely stopped when the temperature of the motor or battery reaches the reference temperature-1.

6. The method of claim 5, wherein when the temperature of the motor or battery reaches the reference temperature-2, said increasing the amount of hydraulic braking further includes increasing the amount of hydraulic breaking to the total amount of braking required as a target value.

7. A braking control method for an electric vehicle, the method comprising:
identifying a vehicle operational condition that reduces regenerative braking capacity;
linearly reducing the amount of regenerative braking of a motor of the electric vehicle after identifying such a vehicle operational condition; and
at the same time, increasing the amount of hydraulic braking of a hydraulic braking system to compensate for the reducing of the amount of regenerative braking.

8. The method of claim 7, wherein said increasing of the amount of hydraulic braking, includes increasing the amount of hydraulic braking to the total amount of braking required as a target value.

9. The braking control method of claim 7, wherein:
the operational condition being identified corresponds to the detection of a position of shift lever in neutral (N) during regenerative braking; and wherein:
wherein said linearly reducing includes linearly reducing the amount of regenerative braking of a motor at a time when the manipulation of the shift lever to the N position is detected; and
said method further comprises allowing the shift lever to be shifted to the N position after a predetermined time from the time when the manipulation of the shift lever to the N position is detected.

10. The braking control method of claim 7, wherein:
the operational condition being identified corresponds to determining whether the temperature of the motor or battery increases and reaches a predetermined reference temperature-2 during regenerative braking; and
said linearly reducing includes linearly reducing the amount of regenerative braking of the motor if the temperature of the motor or battery reaches the reference temperature-2.

11. The method of claim 10, wherein the reference temperature-2 is a temperature set to be lower than a predetermined reference temperature-1, a temperature corresponding to a predetermined level at which the regenerative braking is to be completely stopped.

12. The method of claim 11, wherein the reference temperature-2 is established so that the regenerative braking is completely stopped when the temperature of the motor or battery reaches the reference temperature-1.

13. The method of claim 10, wherein when the temperature of the motor or battery reaches the reference temperature-2, said increasing the amount of hydraulic braking further includes increasing the amount of hydraulic breaking to the total amount of braking required as a target value.
